(19) United States
(12) Patent Application Publication
(10) Pub. No.: US 2025/0020710 A1
(43) Pub. Date: Jan. 16, 2025

(54) SYSTEM AND METHOD FOR VOLTAGE DRIFT MONITORING

(71) Applicant: STMicroelectronics International N.V., Geneva (CH)

(72) Inventors: Francesco Rundo, Gravina di Catania (IT); Carmelo Pino, Catania (IT); Michele Calabretta, Giarre (CT) (IT); Alessandro Sitta, Giardini Naxos (ME) (IT); Angelo Alberto Messina, Catania (IT); Salvatore Coffa, Milano (IT)

(21) Appl. No.: 18/349,791

(22) Filed: Jul. 10, 2023

(51) Int. Cl. G01R 31/26

(52) U.S. Cl. CPC G01R 31/2601

(57) ABSTRACT

A method for monitoring voltage drift includes measuring a voltage across a diode of a power device, providing the measured voltage as an input to a controller, the controller being configured to run a transformer-based model, and forecasting a range of expected future values of the voltage across the diode of the power device with the transformer-based model. The transformer-based model may include a temporal fusion transformer with a temporal convolutional neural network and an adversarial compensation model with a backpropagation algorithm.

### TECHNICAL FIELD

The present invention relates generally to a system and method for voltage drift monitoring, and, in particular embodiments, to a system and method for monitoring power module health.

### BACKGROUND

Power modules are power electronics that can handle large currents. Power modules include power devices, e.g., transistors, diodes, etc. Some types of power devices, such as silicon carbide (SiC) based power devices, may allow for greater power efficiency and/or a higher switching frequency. SiC based power devices may be useful in electric vehicle power applications such as on-board chargers (OBC), electric traction drives, and power converter solutions, as well as industrial applications such as motor drives, solar inverters, charging stations, UPS, welding tools and power converter solutions. In particular, SiC power modules may be useful in cooling systems for traction drives of electric vehicles. However, problems may occur in SiC based power devices for which new solutions are desirable.

### SUMMARY

In accordance with an embodiment, a method for monitoring voltage drift includes: measuring a voltage across a diode of a power device; providing the measured voltage as an input to a controller, the controller being configured to run a transformer-based model, where the transformer-based model includes a temporal fusion transformer with a temporal convolutional neural network, the transformer-based model further including an adversarial compensation model with a backpropagation algorithm; and forecasting a range of expected future values of the voltage across the diode of the power device with the transformer-based model.

In accordance with another embodiment, a method for monitoring health of a power device includes: training an artificial intelligence model with voltage inputs, the voltage inputs being produced by power-cycling a first power device; loading the trained artificial intelligence model into firmware of a microcontroller; and using the trained artificial intelligence model to forecast when a second power device will reach an end of its operational lifetime, the second power device being coupled with the microcontroller.

In accordance with yet another embodiment, a system for monitoring voltage drift includes: a power device; a non-transitory memory including a program; and a microprocessor coupled to the non-transitory memory and the power device, the microprocessor being configured to execute the program, the program including a transformer-based model, where the transformer-based model includes a temporal fusion transformer with a temporal convolutional neural network, the transformer-based model further including an adversarial compensation model with a backpropagation algorithm, and based on the transformer-based model monitoring the voltage drift of the power device and predicting future voltage drift of the power device.

It is to be understood that both the foregoing general description and the following detailed description are exemplary and explanatory only and are not restrictive of the disclosure, as claimed.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1A and 1B illustrate cross-sectional and top-down views of a semiconductor die, in accordance with some embodiments;

FIG. 2 illustrates a top-down view of a power module, in accordance with some embodiments;

FIG. 3A illustrates a block diagram of a system for monitoring voltage drift of a power module, in accordance with some embodiments;

FIG. 3B illustrates a graph of voltage versus time measured across a body diode of a power module, in accordance with some embodiments;

FIG. 4 illustrates a graph of experimental results of predicted and actual drain-source voltages over time for a power module, in accordance with some embodiments;

FIG. 5 illustrates a block diagram of an example AI model, in accordance with some embodiments;

FIGS. 6A and 6B illustrate example graphs of experimental data comparing actual drain-source voltage with predicted drain-source voltage from an AI model, in accordance with some embodiments;

FIG. 7 illustrates a table of error values between predicted drain-source voltage and measured drain-source voltage, in accordance with some embodiments;

FIG. 8 illustrates a flow chart diagram of a method for monitoring health of a power device, in accordance with some embodiments; and

FIG. 9 illustrates a flow chart diagram of a method for monitoring voltage drift, in accordance with some embodiments.

Corresponding numerals and symbols in the different figures generally refer to corresponding parts unless otherwise indicated. The figures are drawn to clearly illustrate the relevant aspects of the embodiments and are not necessarily drawn to scale. The edges of features drawn in the figures do not necessarily indicate the termination of the extent of the feature.

### DETAILED DESCRIPTION OF ILLUSTRATIVE EMBODIMENTS

The making and using of various embodiments are discussed in detail below. It should be appreciated, however, that the various embodiments described herein are applicable in a wide variety of specific contexts. The specific embodiments discussed are merely illustrative of specific ways to make and use various embodiments, and should not be construed in a limited scope.

Power modules (e.g., SiC power modules) may be repetitively heated during their operations due to power losses induced by load current and frequency. These repetitive temperature swings may generate thermal fatigue on device interfaces such as wire bonding. Power loss in devices may increase with degradation due to positive feedback between wire bonding degradation and on-state drain-source voltage of silicon carbide (SiC) MOSFETs. This can lead to undesirable consequences such as system overheating, efficiency loss and, if no countermeasures are taken, complete system failure. If a component or a subsystem of a power electronic system such as a power module shows an abnormal behavior, it may compromise the correct working of the whole system. For automotive applications, these undesired behaviors can have a significant impact on the safety of traction-system safety resulting in an impact on the overall safety of the car. For instance, in electric or hybrid electric vehicles, a fault in a system based on a SiC power module may have an impact on the cooling system of the traction drive. This may affect the entire performance of the electric vehicle engine whole electric car-engine performance with a consequent impact on driving safety.

As such, it is advantageous to identify precursor parameters for power module degradation, to monitor the precursor parameters during operation, and to predict a remaining device lifetime for the power module before a critical threshold for system reliability is reached. This may be useful in avoiding critical device failures.

According to one or more embodiments of the present disclosure, this application relates to systems and methods of voltage drift monitoring in order to monitor and predict the health of a power module (also referred to as a power device). An AI-based algorithm (such as one based on a transformer model) is used to predict the health status of power modules (e.g., SiC power modules) using drain-source voltage (Vas) from the power module as an input. AI-based algorithms based on transformer models combine a self-attention mechanism, parallelization, and positional encoding. The AI-based algorithm may be trained and tested with power cycle testing in order to analyze module interface reliability. The AI-based algorithm may further use Jacobian regularization, an adversarial compensation model, to compensate for noise in the drain-source voltage input.

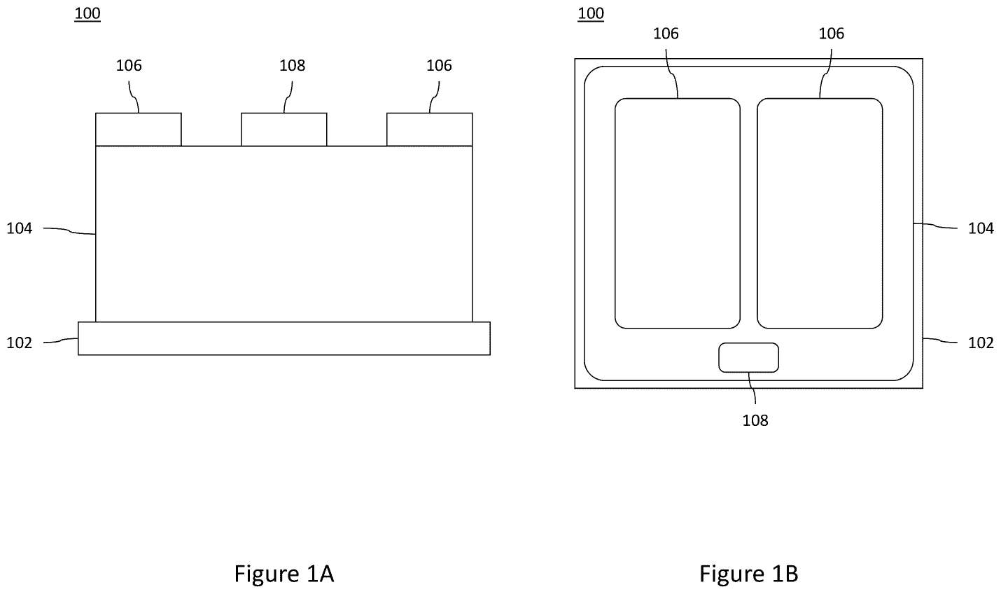

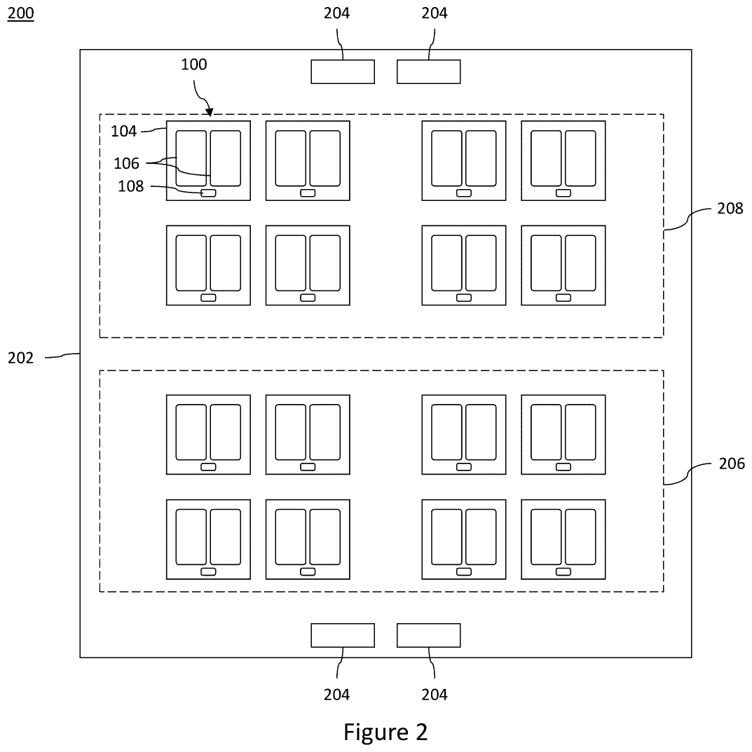

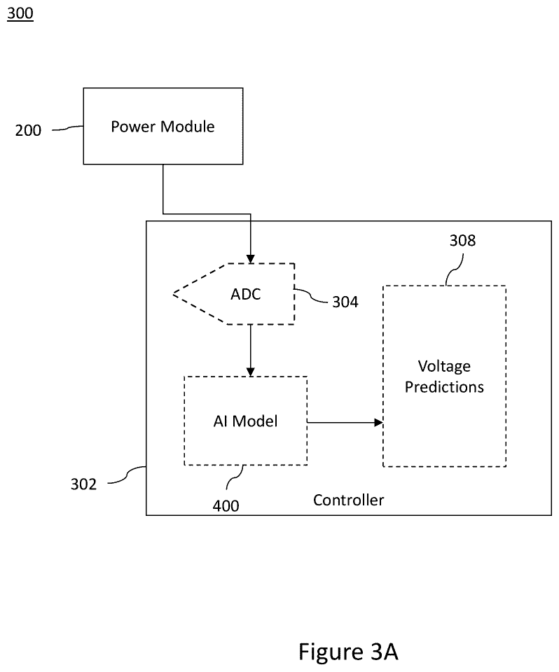

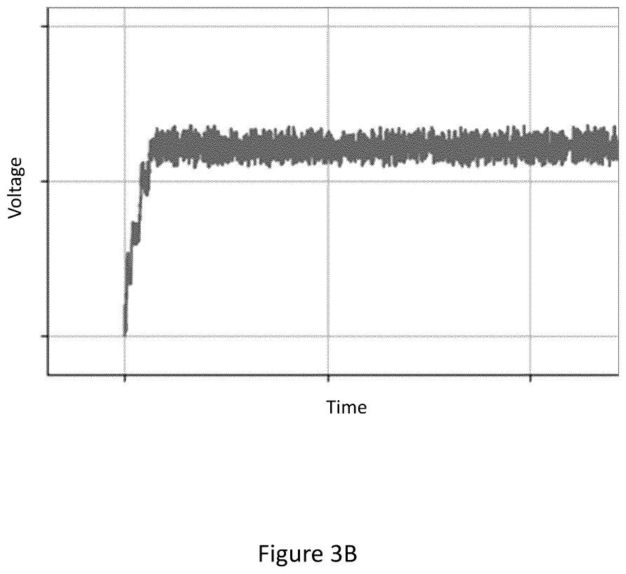

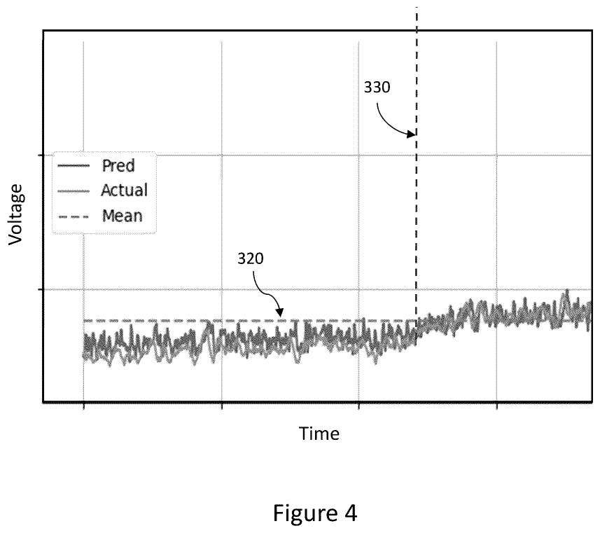

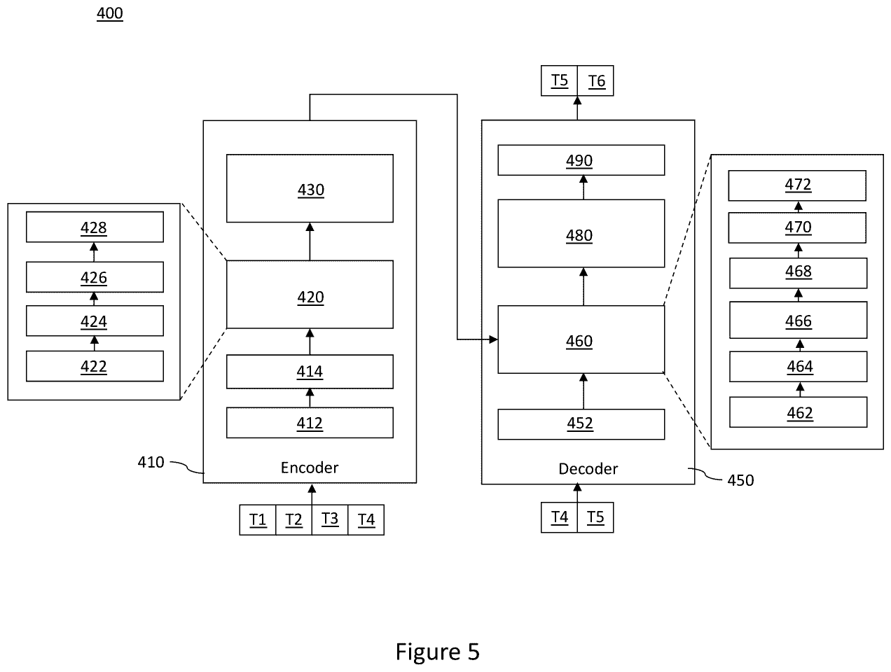

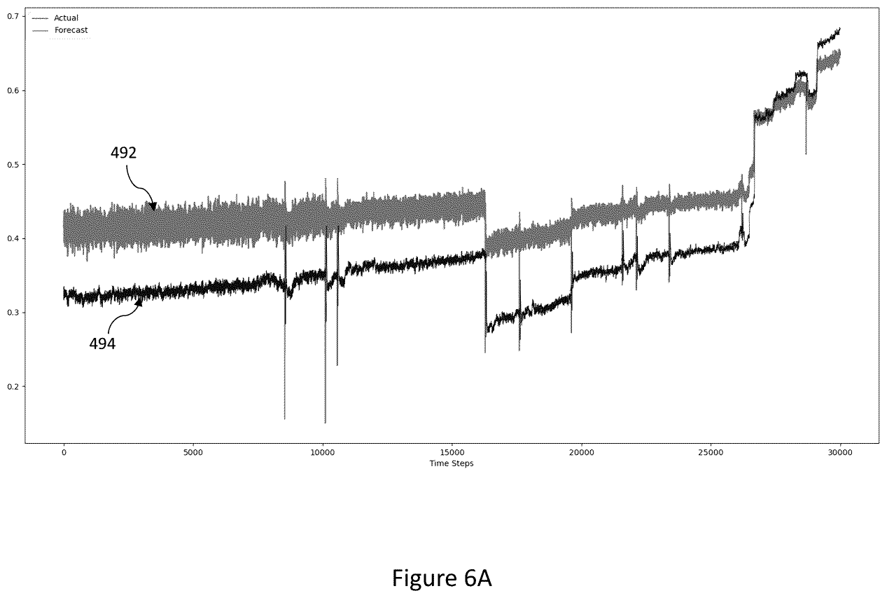

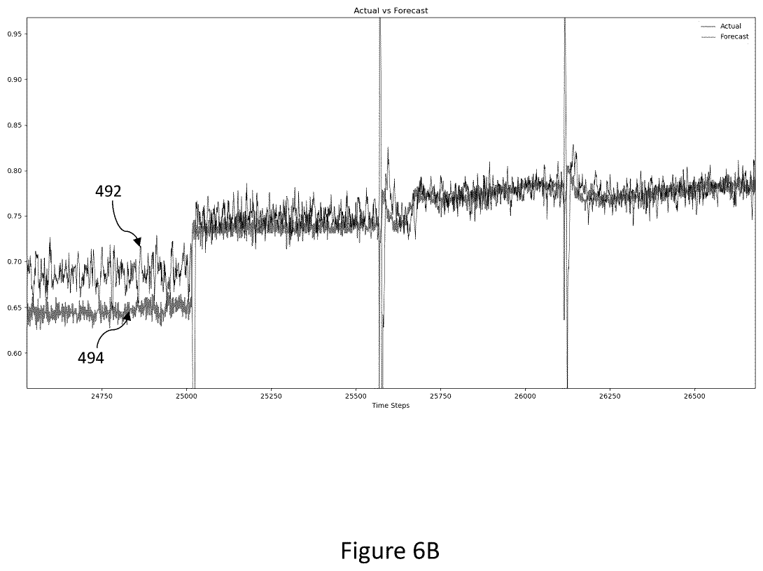

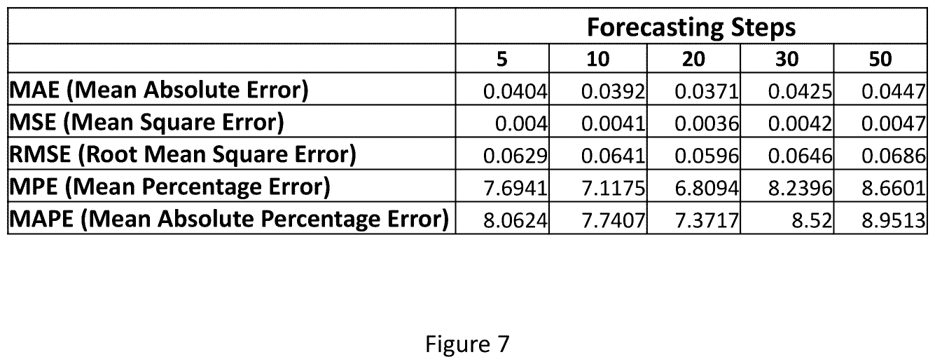

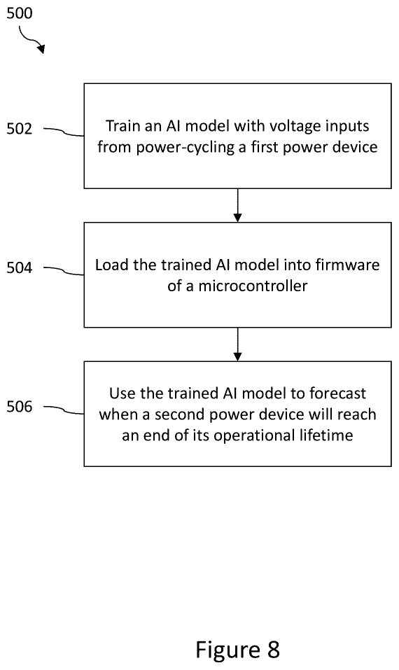

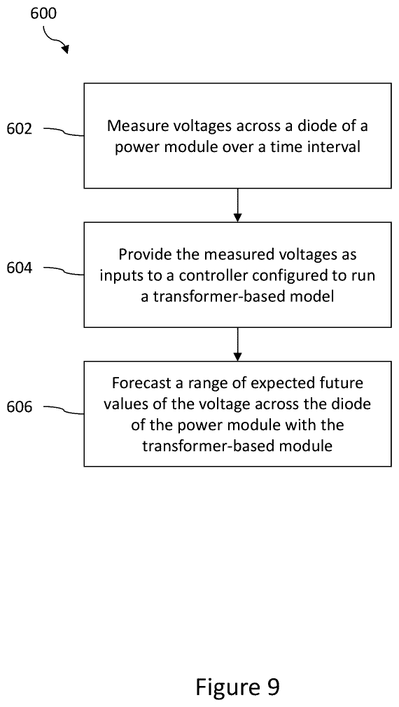

Embodiments of the disclosure are described in the context of the accompanying drawings. An embodiment of an example power module will be described using FIGS. 1A, 1B, and 2. An embodiment of a system for monitoring voltage drift of a power module will be described using FIG. 3A. Experimental results of voltage versus time measured across a body diode of a power module will be described using FIG. 3B. Experimental results of predicted and actual drain-source voltages over time for a power module will be described using FIG. 4. An embodiment of an AI model will be described using FIG. 5. Experimental results of actual drain-source voltage compared with predicted drain-source voltage from an AI model will be described using FIGS. 6A and 6B. Experimental results of error values between predicted drain-source voltage and measured drain-source voltage will be described using FIG. 7. An embodiment of a method for monitoring health of a power device will be described using FIG. 8. An embodiment of a method for monitoring voltage drift will be described using FIG. 9.

FIGS. 1A-1B are views of a power semiconductor die 100. FIG. 1A is a cross-sectional view and FIG. 1B is a top-down view. The power semiconductor die 100 includes a power device capable of operating at a high voltage and/or a high frequency, such as a silicon carbide (SiC) based power device, a gallium nitride (GaN) based power device, or the like. The power device may be a transistor such as a metal-oxide-semiconductor field-effect transistor (MOSFET), a bipolar transistor, or the like; a diode such as a Schottky barrier diode (SBD); or the like. The power semiconductor die 100 may be formed in a suitable front-end of line (FEOL) process by acceptable deposition, photolithography, and etching techniques.

In some embodiments, the power semiconductor die 100 is a silicon carbide die that includes an SiC MOSFET. Such a power semiconductor die 100 includes a drain electrode 102, semiconductor layers 104, source electrodes 106, and a gate electrode 108. Other types of power semiconductor dies may have other arrangements of features. Additionally, it should be appreciated that the power semiconductor die 100 may include other features (not separately illustrated).

The drain electrode 102 may be formed of a conductive material, such as titanium, aluminum, nickel, gold, combinations thereof, or the like, which may be formed by a deposition process such as physical vapor deposition (PVD) or CVD, a plating process such as electrolytic or electroless plating, or the like. The drain electrode 102 may (or may not) be wider than overlying features (e.g., the semiconductor layers 104).

The semiconductor layers 104 are formed on the drain electrode 102. The semiconductor layers 104 include any desired quantity of channel layers, well layers, drift layers, and the like. Each of the semiconductor layers 104 may be formed of silicon; germanium; a compound semiconductor including silicon carbide, gallium arsenide, gallium phosphide, indium phosphide, indium arsenide, and/or indium antimonide; an alloy semiconductor including silicon-germanium, gallium arsenide phosphide, aluminum indium arsenide, aluminum gallium arsenide, gallium indium arsenide, gallium indium phosphide, and/or gallium indium arsenide phosphide; or combinations thereof. Each of the semiconductor layers 104 may be epitaxially grown using a process such as vapor phase epitaxy (VPE) or molecular beam epitaxy (MBE), deposited using a process such as chemical vapor deposition (CVD) or atomic layer deposition (ALD), or the like. In some embodiments, the semiconductor layers 104 include a silicon carbide layer.

The source electrodes 106 and the gate electrode 108 are formed on the semiconductor layers 104. The source electrodes 106 and the gate electrode 108 may each be formed of a conductive material, such as titanium, aluminum, nickel, gold, combinations thereof, or the like, which may be formed by a deposition process such as physical vapor deposition (PVD) or CVD, a plating process such as electrolytic or electroless plating, or the like. The source electrodes 106 and the gate electrode 108 may be formed in the same cross-section (as shown by FIG. 1A) or may be formed in different cross-sections (as shown by FIG. 1B). Additional layers (not separately illustrated), such as dielectric layers, interfacial layers, work function tuning layers, and the like may also be formed. For example, a gate dielectric layer may be formed between the gate electrode 108 and the semiconductor layers 104.

The power semiconductor die 100 of this example includes an SiC MOSFET having a planar structure. Other structures may be utilized. For example, the SiC MOSFET may have a trench structure, such as a single trench structure, a double trench structure, or the like.

FIG. 2 is a top-down view of a power module 200, also referred to as a power device. The power module 200 includes a package substrate 202 and a power electronics circuit, which includes one or more power semiconductor dies 100 mounted to the package substrate 202. The power electronics circuit may be any desired type of circuit, such as a chopper circuit, a DC-to-DC converter circuit, an inverter circuit, or a relay circuit. It should be appreciated that the power electronics circuit may include other circuit elements (not separately illustrated), such as passive devices, a gate driver, or the like, mounted to the package substrate 202. In embodiments where the power semiconductor die 100 are SiC MOSFETs, the power module 200 is an SiC power module. The power electronics circuit may include a plurality of the power semiconductor dies 100. In this example, sixteen power semiconductor dies 100 are utilized. However, the power module 200 may include any suitable number of power semiconductor dies 100. As illustrated in FIG. 2, the power module 200 includes a low-side area 206 closer to battery terminals (not illustrated) and a high-side area 208 farther from the battery terminals. Drain-source voltages measured in either the low-side area 206 or the high-side area 208 may be used for health monitoring and forecasting of the power module 200.

The package substrate 202 includes a substrate core and bond pads over the substrate core. The substrate core may be formed of a semiconductor material such as silicon, germanium, diamond, or the like. The substrate core is, in one alternative embodiment, based on an insulating core such as a fiberglass reinforced resin core. An example core material is fiberglass resin such as FR4. Alternatives for the core material include bismaleimide-triazine BT resin, or alternatively, other PCB materials or films. Build up films such as ABF or other laminates may be used for the substrate core. The substrate core may (or may not) include active and/or passive devices. A wide variety of devices such as transistors, capacitors, resistors, combinations of these, and the like may be used to generate the structural and functional requirements of the design for the power module 200. The devices may be formed using any suitable methods. The substrate core may also include metallization layers and vias (not shown), with the bond pads being physically and/or electrically coupled to the metallization layers and vias. The metallization layers may be formed over the active and passive devices and are designed to connect the various devices to form functional circuitry. The metallization layers may be formed of alternating layers of a dielectric material (e.g., a low-k dielectric material) and a conductive material (e.g., copper) with vias interconnecting the layers of conductive material and may be formed through any suitable process (such as deposition, damascene, dual damascene, or the like). In some embodiments, the substrate core is substantially free of active and passive devices.

The power semiconductor dies 100 are attached to the bond pads of the package substrate 202. For example, conductive connectors (such as reflowable connectors, not separately illustrated) may be used to electrically and/or physically couple the package substrate 202, including metallization layers of the package substrate 202, to the power semiconductor dies 100, such as to the drain electrodes 102 (see FIG. 1A). Wire bonds (not separately illustrated) may be connected to the source electrodes 106 and the gate electrodes 108 (see FIG. 1A). For example, a leg of the power electronics circuit may be formed by coupling together multiple source electrodes 106 of multiple power semiconductor dies 100 with wire bonds. The wire bonds and the metallization layers of the package substrate 202 connect the power semiconductor dies 100 and other circuit elements (if present) together to form a desired power electronics circuit.

The wire bonds of the package substrate 202 may be subjected to repetitive temperature swings, such as from heating induced by load current and frequency during operation of the power semiconductor dies 100. Device interfaces such as the wire bonding may experience thermal fatigue from the temperature swings. Power loss of the power module 200 may increase with degradation of the wire bonds because of positive feedback. This can lead to system overheating, efficiency loss, and complete system failure. It is advantageous to monitor the performance of the power module 200 and forecast when the performance passes a critical point in order to avoid unexpected system failure, such as the shutdown of an automotive application.

The power module 200 may further include external connectors 204. The external connectors 204 may be push pins, in-line package switches, or the like, which may be electrically and/or physically coupled to the metallization layers of the package substrate 202. An external device, such as a device implementing the power module 200, may be connected to the power electronics circuit through the external connectors 204.

Additional features may be included in the power module 200. In some embodiments, the power module 200 also includes a passivation layer (not separately illustrated). The passivation layer is formed on the package substrate 202, the power semiconductor dies 100, the wire bonds, any other circuit elements (if present), etc. such that the passivation layer covers and protects the components of the power module 200.

In order to monitor the health of power modules such as the power module 200, it is advantageous to monitor parameters such as gate-source voltage (V_{GS}), drain-source voltage (V_{DS}), and current of the drain terminal of the power module (I_{D}) with dedicated instruments in real time. These parameters may be measured in order to determine if a power module has reached the effective end of its lifetime due to thermal damage to, for example, wire bonding. For some devices such as SiC power modules, it may be useful to measure source-drain voltage (V_{SD}) across body diodes.

FIG. 3A illustrates a block diagram of a system 300 for monitoring voltage drift of a power module 200 in order to monitor and predict the health of the power module 200, in accordance with some embodiments. The system 300 includes a power module 200 (e.g., a SiC power module as described above in FIGS. 1A, 1B, and 2) that is coupled to a controller 302 in order to provide drain-source voltage data. In some embodiments, the controller 302 is a microcontroller unit (MCU), such as a small computer on a single very large-scale integration (VLSI) integrated circuit chip, and may also be part of a distributed system in certain embodiments. However, the controller 302 may be any suitable processing unit(s), microcontroller unit(s), microprocessor(s), the like, or a combination thereof.

The controller 302 includes an analog-to-digital converter (ADC) 302 and an AI model 400. The ADC 304 may be part of a same chip as the rest of the controller 302 (e.g., an MCU) or it may be an integrated circuit on a separate chip coupled to the rest of the controller 302. In some embodiments, the ADC 304 is a 12 bit ADC. However, the ADC 304 may be any suitable analog-to-digital converter and may have any suitable number of bits, such as 8 to 16 bits.

The AI model 400 is implemented in the programming of the controller 302 by instructions contained in non-transitory memory such as software, firmware, hardware, or a combination thereof. For example, the AI model 400 can be loaded into firmware of the controller 302. However, the controller 302 may also be programmed with the AI model 400 by software instructions, or the controller 302 may contain the instructions for the AI model 400 in its hardware (e.g., as an ASIC). As described below with respect to FIG. 5, the AI model 400 may be a deep learning system such as a transformer-based model. In some embodiments, the AI model 400 is a temporal fusion transformer (TFT) that embeds layers of a temporal convolutional network (TCN) with a multi-head attention block. In some embodiments, the multi-head attention block uses 10 heads. However, the multi-head attention block may have any suitable number of heads.

As illustrated in FIG. 3A, the power module 200 provides input (e.g., drain-source voltage) to the ADC 304. Next, the ADC 304 converts the analog voltage signals from the power module 200 to digital signals and provides the digital signals to the AI model 400 in the controller 302. The AI model 400 uses the digital signals to produce voltage predictions 308, which can be used to forecast future degradation of the performance of the power module 200. Voltage predictions 308 can be used to predict a start of the performance degradation of the power module 200 as well as to monitor the health status of the power module 200, as the voltage drift can be used as an early marker of the performance degradation. For example, the controller 300 may be programmed to produce and display an alert message to a user if degradation of the performance of the power module 200 is predicted to occur within a set time range, such as within twenty weeks of additional use. However, any suitable methods may be performed by the controller 300 to forecast future power module degradation and alert a user.

FIG. 3B illustrates an example graph of voltage versus time for a drain-source voltage measured across a body diode of a power module (e.g., an SiC power module), in accordance with some embodiments. The drain-source voltage may be used as input for the AI model 400, such as an analog voltage signal converted by the ADC 304 to a digital signal.

FIG. 4 illustrates a graph of experimental results of predicted and actual drain-source voltages over time showing a power module reaching the end of its useful lifetime obtained from a power cycling test, in accordance with some embodiments. The actual drain-source voltages may be measured across a body diode of a power module 200 (e.g., an SiC power module), and the predicted drain-source voltages may be obtained from an AI model 400 (see above, FIG. 3A). The interface reliability (e.g., wire bonding) of power modules may be tested using power cycling to simulate accelerated aging compared to normal power module usage.

In a power cycling test, high DC current is cyclically supplied to a power module in order to produce device self-heating in the power module. During cooling phases (in other words, when the high DC current is off), a sensing current (e.g., from voltage probes of a voltage sensor such as a multimeter) is flowed across a body diode of the power module in order to measure the drain-source voltage, which is linearly correlated with the virtual junction temperature (in other words, a temperature representing the temperature of the junction(s) of the power module calculated on the basis of a simplified model of the thermal and electrical behavior of the semiconductor device). This virtual junction temperature may be used as a parameter for measuring and forecasting thermal fatigue of the power module. Relevant physical parameters for thermal fatigue (for example, device temperature swing and coolant temperature) may be set at the beginning of the power cycling test. The drain-source voltage is monitored during the power cycling test. Each time sample in the power cycling test may correspond to a week of real time power module usage in an automotive application (e.g., in an automotive application such as a cooling system for a traction drive of an electric vehicle).

Dashed line 320 is the mean of the predicted and actual drain-source voltages after the effective end of lifetime has been reached, and dashed line 330 is the time when the end of lifetime is reached. The effective end of the operational lifetime of a power module (also referred to as end-of-life of the power module) is characterized by a degradation of interfaces such as wire bonds. This can be observed by a significant increase in the resistance between drain and source R_{DS_ON} of a body diode. A drift of the R_{DS_ON} equal to or greater than 5% may be considered a confirmation of electrical death of the device, beyond which the device should not be used further.

Practical measurement of R_{DS_ON} may involve the measurement of voltage and current in the bridges of the power module. Because of this, the voltage between the drain and source of the bridge (also referred to as low-side drain-source voltage (V_{DS_LS}) and high-side drain-source voltage (V_{DS_HS}), respectively) may be used as a proportional end-of-life marker, as it is directly proportional to the R_{DS_ON}. In FIG. 4, an instance of the low-side drain-source voltage (V_{DS_LS}) is illustrated showing the predicted and actual low-side drain-source voltage drifts over time as the end of lifetime of the device is reached at dashed line 330. As illustrated in FIG. 4, the predicted values for the drain-source voltage match the actual values for the drain-source voltage closely.

FIG. 5 illustrates a block diagram of an example AI model 400 implemented with a transformer-based deep learning system, in accordance with some embodiments. The AI model 400 retrieves a long-term time dependence in an input signal (e.g., drain-source voltage from a power module) in order to predict future values of the input signal, such as to forecast an end of lifetime for a power module. Transformers combine a self-attention mechanism, parallelism, and positional encoding. As illustrated by FIG. 5, the example AI model 400 includes an encoder 410 and a decoder 450. The encoder 410 includes an input layer 412, a position encoding layer 414, a first encoder layer 420, and a second encoder layer 430. The first encoder layer includes a self-attention layer 422, a first add and normalize layer 424, a feed forward layer 426, and a second add and normalize layer 430. The input layer 412 parses input (e.g., digitized drain-source voltage signals from a power module 200) into tokens (e.g., tokens T1, T2, T3, and T4), which are converted into a vector by a word embedding. The position encoding layer 414 then adds positional information of the tokens to the word embedding of the vector.

Next, encoding layers of the encoder 410 (e.g., first encoder layer 420 and second encoder layer 430) that process the input iteratively one layer after another. Each encoder layer makes use of an attention mechanism (e.g, the self-attention layer 422). For each part of the input, the attention mechanism weighs the relevance of every other part and draws from them to produce the output. Each encoder sublayer of the encoder 410 layers (e.g., first encoder layer 420 and second encoder layer 430) generates encodings that contain information about which parts of the inputs are relevant to each other. Each encoder sublayer then passes its encodings to the next encoder sublayer as inputs. For example, the self-attention layer 422 (which may include a multi-headed attention head) encodes relevance relations between each token. In the context of the current disclosure, this may be useful for predicting future voltage drift in power modules based on past voltage drift used in the training of the AI model 400.

The self-attention layer 422 then passes its encodings to the first add and normalize layer 424, which adds and normalizes the encodings based on weights from the self-attention layer 422. The first add and normalize layer 424 then passes its encodings to the feed forward layer 426. This may be a feed forward neural network for additional processing of the encodings that contains residual connections and additional layer normalization steps. Next, the feed forward layer 426 passes the encodings to the second add and normalize layer 428, which adds and normalizes the encodings based on weights from the feed forward layer 426. Although the first encoder layer 420 is illustrated as having one self-attention layer, two add and normalize layers, and one feed forward layer, the first encoder layer 420 may have any suitable number and arrangement of encoder sublayers, and all such combinations are within the scope of the disclosed embodiments.

The first encoder layer 420 then passes its encodings to the second encoder layer 430, which may have a similar structure with similar encoder sublayers as the first encoder layer 420. As such, the details are not repeated herein. The second encoder layer 430 then passes its encodings (e.g., the tokens T4 and T5) to the decoder 450.

The decoder 450 includes decoding sublayers that process the output of the encoder 410 iteratively one layer after another. Each decoder layer of the decoder 450 performs in the opposite manner from the encoder layers of the encoder 410 by receiving encodings from the encoder 410 and using their incorporated contextual information to produce an output sequence. The decoder 450 includes an input layer 452, a first decoder layer 460, a second decoder layer 480, and a linear mapping layer 490. The input layer 452 receives encodings from the encoder 410 (e.g., the tokens T4 and T5) and passes them to the first decoder layer 460.

In the example illustrated by FIG. 5, the first decoder layer 460 of the decoder 450 includes a self-attention layer 462, a first add and normalize layer 464, an encoder-decoder attention layer 466, a second add and normalize layer 468, a feed forward layer 470, and a third add and normalize layer 472. Each decoder layer has an additional attention mechanism (e.g., the encoder-decoder attention layer 466) that draws information from the outputs of previous decoder layers before the decoder layer draws information from the encodings.

The self-attention layer 462 may encode relevance relations between each token in a similar manner as described above with respect to the self-attention layer 422. The self-attention layer 462 then passes its output to the first add and normalize layer 464, which adds and normalizes the output based on weights from the self-attention layer 462. The first add and normalize layer 464 then passes its encodings to the encoder-decoder attention layer 466, which draws information from the outputs of previous decoder layers. The encoder-decoder attention layer 466 passes its output to the second add and normalize layer 468, which adds and normalizes the output based on weights from the encoder-decoder attention layer 466. The second add and normalize layer 468 passes its outputs to the feed forward layer 470, which may be a feed forward neural network for additional processing of the encodings that contains residual connections and additional layer normalization steps. The feed forward layer 470 passes the encodings to the third add and normalize layer 472, which adds and normalizes the encodings based on weights from the feed forward layer 470.

Although the first decoder layer 450 is illustrated as having one self-attention layer, one feed forward layer, one encoder-decoder layer, and three add and normalize layers, the first decoder layer 450 may have any suitable number and arrangement of decoder sublayers, and all such combinations are within the scope of the disclosed embodiments.

The first decoder layer 450 then passes its output to the second decoder layer 480, which may have a similar structure with similar encoder sublayers as the first decoder layer 450. As such, the details are not repeated herein. Next, the second decoder layer 480 passes its output to the linear mapping layer 490, which maps the output to tokens (e.g., tokens T5 and T6). The tokens T5 and T6 are predicted to be next in the sequence of tokens T1 to T4 and can be compared with actual data to further train the AI model 400.

Although the example of FIG. 4 illustrates the encoder 410 and the decoder 450 each having two respective encoder and decoder layers, the encoder 410 and the decoder 450 may each have any suitable number of encoder and decoder layers (e.g., five encoder and decoder layers), and all such combinations are within the scope of the disclosed embodiments.

In some embodiments, the transformer-based deep learning system of the AI model 400 is a Temporal Fusion Transformer (TFT). A TFT is an attention-based deep neural network that may be used for multi-horizon data forecasting. An example of a TFT is described in: “B. Lim, S. O. Arik, N. Loeff, and T. Pfister, ‘Temporal fusion transformers for interpretable multi-horizon time series forecasting,’ International Journal of Forecasting, vol. 37, no. 4, pp. 1748-1764, 2021. [Online]. Available: https://www.sciencedirect.com/science/article/pii/S0169207021000637,” which is hereby incorporated by reference in its entirety.

The temporal fusion transformer (TFT) consists of a multi-layered encoder-decoder architecture, incorporating self-attention mechanisms to capture and model temporal dependencies. The encoder receives input sequential data and employs self-attention layers to compute contextualized representations at each time step. The self-attention mechanism allows the TFT to weigh the importance of different elements within the sequence (e.g., voltage drift of drain-source voltage data from a power module undergoing a power cycling test) by considering both local and global information. This enables the TFT to capture long-range dependencies and contextual relationships across the entire sequence. This is advantageous for predicting future behavior of a time-dependent data sequence, such as voltage drift of drain-source voltage from a power module.

The decoder component of the TFT further enhances the analysis and prediction capabilities by fusing the temporal information across multiple time steps. Through the fusion process, the decoder utilizes the contextualized representations obtained from the encoder to generate accurate predictions or perform downstream tasks on the sequential data. The temporal fusion enables the TFT to incorporate historical information while making predictions, thereby improving the overall accuracy and robustness of the system.

Furthermore, the TFT can be extended to incorporate additional components, such as positional encodings, feed-forward neural networks, or auxiliary tasks to enhance its performance and adaptability to specific applications. These extensions allow the TFT to handle sequential data with varying characteristics and domain-specific requirements.

The TFT is able to reach high performance with respect to classical deep architectures usually employed for 1D time-series forecasting such as Long Short-Term Memory (LSTM) networks, Temporal Convolutional Neural (TCN) networks, or the like. The TFT includes internal processing blocks such as: a static covariate encoder block to encode context vectors of additional input data which can be used to boost the overall prediction performance of the TFT; a Gated Residual Network (GRN) combined with a variable selection layer which can decrease the impact of irrelevant input data; a Sequence-to-Sequence (Seq2Seq) encoding/decoding block for performing a local encoding/decoding of the input data including past input data as well as known future input data (with past and future measured relative to some point in time in the input data sequence); and a temporal self-attention decoder to learn long-term dependencies embedded in the input data. Additionally, in some embodiments the TFT uses a Temporal Convolutional Neural network. An example of a TCN is described in: “S. Bai, J. Z. Kolter, and V. Koltun, ‘An empirical evaluation of generic convolutional and recurrent networks for sequence modeling,’ ArXiv, vol. abs/1803.01271, 2018,” which is herein incorporated by reference in its entirety.

TCNs are deep architecture with embeddings of causal convolutions. In other words, TCNs may process input with a hypothesis that no information leakage occurs from future data samples to past data samples. Past data and future samples are measured relative to some point in time in the input data sequence, so future samples are samples that already exist in the input data sequence rather than samples that have yet to be measured. As an example, a TCN may take an input sequence of any length and map it to an output sequence of the same length. The performance of TCNs in time-series forecasting may be better than classical deep architectures including recurrent network and linear regressors. Sequence-to-sequence (Seq2Seq) encoding/decoding of the pre-processed input data in the TCN may provide intelligent assessment of the temporal sequential data. Using local correlations between time-series data, discriminative features are constructed to improve performance of downstream deep system embedding attention-based processing. The discrimination between input past data and input future samples enables the implemented pipeline to embed deep layers for encoding past data and decoding future samples.

The AI model 400 further includes an adversarial compensation model, such as a model using Jacobian regularization, to compensate for noise in the drain-source voltage input. In some embodiments, a backpropagation algorithm computes the gradient of a loss function with respect to the weights of a network of the AI model 400 (e.g., a feed forward neural network). The loss function may be a Mean Square Error (MSE) loss function. However, any suitable loss function may be used. Any suitable optimization algorithm may be used, such as a stochastic gradient descent (SGD) optimizer or an Adam optimizer. In some embodiments, the learning rate (LR) value of the optimizer is set to 0.0001.

The weights of the loss function are trained by backpropagation, which is a propagation of the error contributions (via the gradients) through the weights of the network. Using Jacobian regularization, the gradients can be forced to keep oscillation due to noise in the drain-source voltage input within a desired range, such as a range of within 5% of the maximum voltage input values.

In some embodiments, the AI model 400 is trained using a power cycling method while the AI model 400 is run on, for example, a server with one or more GPU cores. The AI model 400 may be trained for a suitable amount of time. In some embodiments, the AI model 400 is trained for ten to two hundred epochs, such as one hundred epochs. The trained AI model 400 may then be loaded into firmware of a microcontroller unit (e.g., the controller 302; see above, FIG. 3A).

FIGS. 6A and 6B illustrate graphs of experimental data comparing actual voltage drift of a drain-source voltage of a power module with predicted voltage drift from an AI model (e.g., the AI model 400). FIG. 6A illustrates a trace 492 of the actual, measured drain-source voltage overlaid with a trace 494 of the predicted drain-source voltage over 30000 time steps, and FIG. 6B illustrates the traces 492 and 494 over a window of 24500 to 26750 time steps. Each time step corresponds to one power cycling step, which is equivalent to a certain time interval depending on the type of tested power module, the technology being tested, or the like. On average, a temporal mapping of one time step to one week of regular operation of the power module may be a good approximation, although this relation can vary according to the technical characteristics of the monitored device. In the case of one time step to one week of regular operations temporal mapping, the trace 494 forecasts the predicted voltage drift by 20 steps, which is equivalent to predicting the voltage drift by 20 weeks in advance. As illustrated in FIGS. 6A and 6B, the predicted drain-source voltage of the trace 494 matches the actual drain-source voltage very well, including a significant voltage increase at about the time step 25000 when the power module reaches an end of lifetime state due to interface degradation. A vertical offset in amplitude between the traces 492 and 494 is present due to physical factors of the system but does not affect the accuracy of the predicted drain-source voltage of the trace 494 with regard to forecasting the behavior of the actual drain-source voltage of the trace 492. As such, FIGS. 6A and 6B indicate that the AI model 400 may be used to forecast the health of a power module by a significant period in advance, such as twenty weeks.

FIG. 7 illustrates a table of error values between predicted drain-source voltage of a power module (such as predicted by an AI model 400) and actual, measured drain-source voltage of the power module at various ranges of forecasting steps in advance, including 5, 10, 20, 30, and 50 steps in advance. Values of mean absolute error, mean square error, root mean square error, mean percentage error, and mean absolute percentage error are displayed. As such, a smallest value of mean absolute percentage error (7.3717) is obtained with a forecasting interval of 20 steps in advance, equivalent to 20 weeks of regular power module operation in an automotive application.

FIG. 8 illustrates a flow chart diagram of a method 500 for monitoring health of a power device, in accordance with some embodiments. In step 502, an AI model (e.g., the AI model 400; see above, FIG. 3A) is trained with voltage inputs obtained from power-cycling a first power device (e.g., a power module 200; see above, FIG. 2). In step 504, the trained AI model is loaded into firmware of a microcontroller (e.g., the controller 302; see above, FIG. 3A). In step 506, the trained AI model is used to forecast when a second power device (e.g., another power module 200) will reach an end of its operational lifetime. The second power device is coupled with the microcontroller.

FIG. 9 illustrates a flow chart diagram of a method 600 for monitoring voltage drift, in accordance with some embodiments. In step 602, a voltage is measured across a diode of a power module 200. In step 604, the measured voltage is provided as an input to a controller 300 that is configured to run a transformer-based model (e.g., an AI model 400), as described above with respect to FIG. 3A. The transformer-based model comprises a temporal fusion transformer with a temporal convolutional neural network and an adversarial compensation model with a backpropagation algorithm, as described above with respect to FIG. 5. In step 606, a range of expected future values of the voltage across the diode of the power module is forecast with the transformer-based model, as described above with respect to FIGS. 6A-6B.

Embodiments may achieve advantages. An AI-based algorithm can robustly characterize the health monitoring of power modules and predict future degradation of performance. The AI-based algorithm may be trained by drain-source voltage inputs generated by repeatedly power-cycling a power module. The AI-based algorithm includes techniques such as regularization of the Jacobian of the gradient of the inputs. This may compensate for likely measurement and conversion noises occurring in a system based on a controller (e.g., a microcontroller unit). The AI-based algorithm may accurately forecast power module faults for weeks in advance through monitoring of drain-source voltage drift as a predictive marker.

Example embodiments of the disclosure are summarized here. Other embodiments can also be understood from the entirety of the specification as well as the claims filed herein.

Example 1. A method for monitoring voltage drift, the method including: measuring a voltage across a diode of a power device; providing the measured voltage as an input to a controller, the controller being configured to run a transformer-based model, where the transformer-based model includes a temporal fusion transformer with a temporal convolutional neural network, the transformer-based model further including an adversarial compensation model with a backpropagation algorithm; and forecasting a range of expected future values of the voltage across the diode of the power device with the transformer-based model.

Example 2. The method of example 1, where the adversarial compensation model is configured to compensate for noise with Jacobian regularization.

Example 3. The method of one of examples 1 or 2, further including training the transformer-based model with a power cycling test.

Example 4. The method of one of examples 1 to 3, further including forecasting when the power device will reach an end of its operational lifetime based on the range of expected future values of the voltage across the diode of the power device.

Example 5. The method of one of examples 1 to 4, where the temporal fusion transformer includes a multi-head attention block.

Example 6. The method of one of examples 1 to 5, where the backpropagation algorithm computes a gradient of a loss function, the loss function being a Mean Square Error (MSE) loss function.

Example 7. A method for monitoring health of a power device, the method including: training an artificial intelligence model with voltage inputs, the voltage inputs being produced by power-cycling a first power device; loading the trained artificial intelligence model into firmware of a microcontroller; and using the trained artificial intelligence model to forecast when a second power device will reach an end of its operational lifetime, the second power device being coupled with the microcontroller.

Example 8. The method of example 7, where the voltage inputs are drain-source voltages across a body diode of the first power device.

Example 9. The method of one of examples 7 or 8, where the first power device and the second power device include silicon carbide MOSFETs.

Example 10. The method of one of examples 7 to 9, where the trained artificial intelligence model forecasts when the second power device reaches the end of its operational lifetime at least two weeks before the end of its operational lifetime is reached.

Example 11. The method of one of examples 7 to 10, where the artificial intelligence model includes a temporal fusion transformer.

Example 12. The method of example 11, where the temporal fusion transformer includes a temporal convolutional neural network.

Example 13. The method of one of examples 7 to 12, where training the artificial intelligence model includes an adversarial compensation model using Jacobian regularization.

Example 14. The method of one of examples 7 to 13, where the second power device is coupled to an electric traction drive.

Example 15. The method of one of examples 7 to 14, where the first power device and the second power device are different power devices.

Example 16. A system for monitoring voltage drift, the system including: a power device; a non-transitory memory including a program; and a microprocessor coupled to the non-transitory memory and the power device, the microprocessor being configured to execute the program, the program including a transformer-based model, where the transformer-based model includes a temporal fusion transformer with a temporal convolutional neural network, the transformer-based model further including an adversarial compensation model with a backpropagation algorithm, and based on the transformer-based model monitoring the voltage drift of the power device and predicting future voltage drift of the power device.

Example 17. The system of example 16, where the non-transitory memory is firmware.

Example 18. The system of one of examples 16 or 17, where the power device is a SiC power device.

Example 19. The system of one of examples 16 to 18, where the power device is coupled to a cooling system of a traction drive.

Example 20. The system of one of examples 16 to 19, where the program further includes instructions to produce an alert message in response to determining that degradation of the performance of the power device is predicted to occur within twenty weeks of additional use.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for monitoring voltage drift, the method comprising:
measuring a voltage across a diode of a power device;
providing the measured voltage as an input to a controller, the controller being configured to run a transformer-based model, wherein the transformer-based model comprises a temporal fusion transformer with a temporal convolutional neural network, the transformer-based model further comprising an adversarial compensation model with a backpropagation algorithm; and
forecasting a range of expected future values of the voltage across the diode of the power device with the transformer-based model.

2. The method of claim 1, wherein the adversarial compensation model is configured to compensate for noise with Jacobian regularization.

3. The method of claim 1, further comprising training the transformer-based model with a power cycling test.

4. The method of claim 1, further comprising forecasting when the power device will reach an end of its operational lifetime based on the range of expected future values of the voltage across the diode of the power device.

5. The method of claim 1, wherein the temporal fusion transformer comprises a multi-head attention block.

6. The method of claim 1, wherein the backpropagation algorithm computes a gradient of a loss function, the loss function being a Mean Square Error (MSE) loss function.

7. A method for monitoring health of a power device, the method comprising:
training an artificial intelligence model with voltage inputs, the voltage inputs being produced by power-cycling a first power device;
loading the trained artificial intelligence model into firmware of a microcontroller; and
using the trained artificial intelligence model to forecast when a second power device will reach an end of its operational lifetime, the second power device being coupled with the microcontroller.

8. The method of claim 7, wherein the voltage inputs are drain-source voltages across a body diode of the first power device.

9. The method of claim 7, wherein the first power device and the second power device comprise silicon carbide MOSFETs.

10. The method of claim 7, wherein the trained artificial intelligence model forecasts when the second power device reaches the end of its operational lifetime at least two weeks before the end of its operational lifetime is reached.

11. The method of claim 7, wherein the artificial intelligence model comprises a temporal fusion transformer.

12. The method of claim 11, wherein the temporal fusion transformer comprises a temporal convolutional neural network.

13. The method of claim 7, wherein training the artificial intelligence model comprises an adversarial compensation model using Jacobian regularization.

14. The method of claim 7, wherein the second power device is coupled to an electric traction drive.

15. The method of claim 7, wherein the first power device and the second power device are different power devices.

16. A system for monitoring voltage drift, the system comprising:
a power device;
a non-transitory memory comprising a program; and
a microprocessor coupled to the non-transitory memory and the power device, the microprocessor being configured to execute the program, the program comprising a transformer-based model, wherein the transformer-based model comprises a temporal fusion transformer with a temporal convolutional neural network, the transformer-based model further comprising an adversarial compensation model with a backpropagation algorithm, and based on the transformer-based model monitoring the voltage drift of the power device and predicting future voltage drift of the power device.

17. The system of claim 16, wherein the non-transitory memory is firmware.

18. The system of claim 16, wherein the power device is a SiC power device.

19. The system of claim 16, wherein the power device is coupled to a cooling system of a traction drive.

20. The system of claim 16, wherein the program further comprises instructions to produce an alert message in response to determining that degradation of the performance of the power device is predicted to occur within twenty weeks of additional use.
